(19) United States
(12) Patent Application Publication
(10) Pub. No.: US 2021/0016953 A1
(43) Pub. Date: Jan. 21, 2021

(54) FOOD CONTAINER WITH STEAM EXHAUST DEVICE AND CLOSURE DEVICE THEREOF

(71) Applicant: KUNG LONG HONG CO., LTD, Taichung City (TW)

(72) Inventor: KUO-HSIANG TZU, Taichung City (TW)

(21) Appl. No.: 16/513,693

(22) Filed: Jul. 16, 2019

(51) Int. Cl. B65D 81/34; B65D 77/20; B32B 27/36; B32B 27/32; B32B 27/08; B32B 27/34

(52) U.S. Cl. CPC B65D 81/3453; B65D 77/2024; B65D 81/3461; B32B 27/36; B32B 27/32; B65D 2581/3445; B32B 27/34; B32B 2255/10; B32B 2255/24; B32B 2439/62; B32B 2439/46; B32B 27/08

(57) ABSTRACT

A food container includes a case including a food storage space, a peripheral flange on tops of the case, a first heat joining area on the peripheral flange, and a first less adhesive area on the first heat joining area; a closure device including a heat sealing layer, an outer layer attached to the heat sealing layer, a second heat joining area on a peripheral edge of the closure device and corresponding to the first heat joining area, and a second less adhesive area on the second heat joining area and corresponding to the first less adhesive area; and a non-sticky after heated lacquer layer disposed between and at the first and second less adhesive areas. After heating the container, the non-sticky after heated lacquer layer is softened and does not adhere to the second less adhesive area to form an exit for releasing both steam and pressure.

### BACKGROUND OF THE INVENTION

### 1. Technical Field

The technical field relates to a food packaging, and more particularly relates to a food container having a steam exhaust device for releasing both steam and pressure during heating and a closure device thereof.

### 2.Description of Related Art

Conventionally, food containers (hereinafter called containers) are sealed by a leak-proof plastic closure device. Steam may accumulate quickly during heating, especially for microwave heating, and in turn, pressure in the container increases greatly. The container may explode if the pressure is not released sufficiently. This is not only very dangerous but also may scatter the food contained in the container on the table or ground. Unfortunately, cleaning the mess is a laborious job. Conventionally, it is required to tear or cut the closure device before placing the container in a microwave oven for heating. However, it is inconvenient. Further, people may forget to tear or cut the closure device. As a result, an undesired explosion occurs.

Taiwan Utility Model Numbers M505475 and M495350 (which corresponds to U.S. application Ser. No. 14/576,187) both disclose a food container having a steam exhaust device for releasing steam during heating and composite closure device thereof. The composite closure device comprises a first layer, a second layer and an adhesive layer. A release layer having a predetermined width is partially formed on the first layer. A plurality of perforations corresponding to the release layer are formed on the second layer. The adhesive layer is disposed between the first layer and the second layer to bind the first and second layers together. The release layer is used to temporarily bind the first and second layers together. The second layer is adhered to an opening of the container. The release layer on the second layer extends from the opening for sealing to a position inside the container. Pressure in the container increases greatly when it is subjected to microwave heating. Pressurized air passes the perforations to enter the temporary binding area to form a gap between the first layer and the second layer. Pressure is released, thereby preventing the container from being exploded. However both patents and other containers for microwave heating having a composite closure device (e.g., disclosure of Taiwan Invention Patent Number TWI260270) have the following drawbacks.

1. Conventionally, material for forming a container having a composite closure device comprises a plurality of layers with perforations, applied adhesive and release agent. The manufacturing processes are tedious and the structure of the container is complicated. Further, its manufacturing cost is very high and its production is low due to molding and further processing. 2. Perforations are formed on the composite closure device for forming an exhaust channel. However, foreign objects (e.g., chips) may enter the container to contaminate the food via the perforations. As a result, both hygiene and food safety are adversely affected. 3. There are obstructions formed between adjacent layers of the composite closure device and they may hinder or even block exhaust. It is typical that exhaust rate ranges from 70% to 80%. 4. The perforations on the composite closure device of the container are visually unattractive.

Taiwan Utility Model Numbers M430448 discloses a food storage container comprising a main body (e.g., bag) and a temporary binding area formed of release agent, adhesive, wax and resin which can be melted by heating. Thus, adhesiveness is lowered. And in turn, pressurized hot air may leave the container via the open temporary binding area to release pressure. Otherwise, the container may explode. After cooling, the temporary binding area is closed again by the adhesive and other binding agents. This has advantages of preventing food from leaving the container and preventing foreign objects from entering the container.

The present inventor has found the following problems after experiencing above patent. In detail, the binding agents are sticky and may glue the temporary binding area. And in turn, it blocks the steam exit through the temporary binding area. Thus, the steam exhaust may exit through other portions of the container. To the worse, the container may explode. Its performance is not acceptable.

Thus, the need for improvement still exists.

### SUMMARY OF THE INVENTION

The disclosure is directed to a food container having a steam exhaust device and closure device thereof for eliminating drawbacks including those associated with the conventional art.

In one aspect, the invention is to provide a food container comprising a case including a space for containing food, an opening communicating the space with exterior, a peripheral flange formed on tops of the case, a first heat joining area formed on the peripheral flange, and a first less adhesive area formed on a predetermined position of the first heat joining area; a closure device including a heat sealing layer, an outer layer attached to the heat sealing layer and configured to attach to the peripheral flange, a second heat joining area formed on a peripheral edge of the closure device and corresponding to the first heat joining area, and a second less adhesive area formed on a predetermined position of the second heat joining area and corresponding to the first less adhesive area; and a non-sticky after heated lacquer layer, between the peripheral flange of the case and the closure device, disposed at both the first less adhesive area and the second less adhesive area; wherein the case is formed of a first material and the closure device is formed of a second material configured to join the first material by heating so that after joining the closure device and the case by heating, the first heat joining area and the second heat joining area are secured together, the first less adhesive area and the second less adhesive area are secured together, water in the food evaporates to form steam, pressure of the space is increased, the non-sticky after heated lacquer layer is softened by the heat to become non-sticky, the non-sticky after heated lacquer layer does not adhere to the second less adhesive area to form an exit between the first less adhesive area and the second less adhesive area, the pressure in the space is released through the exit, and the steam in the space leaves the space through the exit.

One of the exemplary embodiments, a material of the case is PP, a material of the heat sealing layer of the closure device is LLDPE, a material of the outer layer is PET, and the non-sticky after heated lacquer layer is formed of hot lacquer type heat sealant having a serial number AD-1790-15 produced by TOYO-MORTON, LTD.

One of the exemplary embodiments, a material of the case is PE, a material of the heat sealing layer of the closure device is CPP, a material of the outer layer is PET, and the non-sticky after heated lacquer layer is formed of hot lacquer type heat sealant having a serial number AD-1790-15 produced by TOYO-MORTON, LTD.

In another aspect, the invention is to provide a food container comprising a bag including an upper shell, a lower shell having two sides and a first end formed with the upper shell, a space defined by the upper and lower shells for containing food, an opening at second ends of the upper and lower shells, an upper heat joining area on the upper shell facing the opening, an upper less adhesive area formed on a predetermined position of the upper heat joining area, a lower heat joining area formed on the lower shell facing the upper heat joining area, and a lower less adhesive area formed on a predetermined position of the lower heat joining area and aligned with the upper less adhesive area; and a non-sticky after heated lacquer layer, between the upper shell and the lower shell, disposed at both the upper less adhesive area and the lower less adhesive area; wherein after sealing the opening of the bag by heating, the upper and lower heat joining areas are secured together, the upper and lower less adhesive areas are secured together by the non-sticky after heated lacquer layer, water in the food evaporates to form steam, pressure of the space is increased, the non-sticky after heated lacquer layer is softened by the heat to become non-sticky, the non-sticky after heated lacquer layer does not adhere to the lower less adhesive area to form an exit between the upper less adhesive area and the lower less adhesive area, the pressure in the space is released through the exit, and the steam in the space leaves the space through the exit.

One of the exemplary embodiments, a material of the heat sealing layer of each of the upper shell and the lower shell is LLDPE or CPP, a material of the outer layer is nylon or PET, and the non-sticky after heated lacquer layer is formed of hot lacquer type heat sealant having a serial number AD-1790-15 produced by TOYO-MORTON, LTD.

One of the exemplary embodiments, a material of the heat sealing layer of each of the upper shell and the lower shell is CPP, a material of the outer layer is OPP, and the non-sticky after heated lacquer layer is formed of hot lacquer type heat sealant having a serial number AD-1790-15 produced by TOYO-MORTON, LTD.

One of the exemplary embodiments, a material of the non-sticky after heated lacquer layer is EVA resin for coating.

Yet in another aspect, the invention is to provide a closure device configured to seal a food container, comprising a heat sealing layer, an outer layer, a heat joining area formed on the closure device, a less adhesive area formed on a predetermined position of the heat joining area, and a non-sticky after heated lacquer layer formed on the less adhesive area.

One of the exemplary embodiments, a material of the heat sealing layer is LLDPE or CPP, and a material of the outer layer is nylon or PET.

One of the exemplary embodiments, a material of the heat sealing layer is CPP and a material of the outer layer is OPP.

One of the exemplary embodiments, the non-sticky after heated lacquer layer is formed of hot lacquer type heat sealant having a serial number AD-1790-15 produced by TOYO-MORTON, LTD.

One of the exemplary embodiments, a material of the non-sticky after heated lacquer layer is EVA resin for coating.

The food container having a steam exhaust device of the invention has the following advantages and benefits in comparison with the conventional art: No perforations on the opening are required. Multi-layer composite closure device is not required. Manufacturing processes are decreased greatly. Production is increased greatly. Being aesthetic due to no perforations. No foreign objects (e.g., chips) are allowed to enter the container to contaminate the food via the perforations. Steam blockage or hindrance at the temporary binding area of the exit as experienced by the conventional multi-layer composite closure device is eliminated. After a plurality of experiments, it is found that all steam can quickly leave the container without obstructions due to the provision of the non-sticky after heated lacquer layer at the exit.

The above and other aspects, features and advantages of the invention will become apparent from the following detailed description taken with the accompanying drawings.

### BRIEF DESCRIPTION OF THE DRAWINGS

FIG. 1 is an exploded view of a food container according to a first preferred embodiment of the invention;

FIG. 2 is a longitudinal sectional view of the closure device;

FIG. 3 is a perspective view of the sealed food container;

FIG. 4 is a sectional view taken along line 4-4 of FIG. 3 where the food is not heated;

FIG. 5 is a view similar to FIG. 4 showing steam exits after heating the food container;

FIG. 6 is an exploded, perspective view of a food container according to a second preferred embodiment of the invention;

FIG. 7 is a perspective view of the sealed food container of FIG. 6;

FIG. 8 is a sectional view taken along line 8-8 of FIG. 7 wherein the food is not heated;

FIG. 9 is a view similar to FIG. 8 showing steam exits after heating the food container;

FIG. 10 is a longitudinal sectional view of the closure device of the second preferred embodiment; and

FIG. 11 is a view similar to FIG. 10 showing another configuration of the closure device of the second preferred embodiment.

### DETAILED DESCRIPTION OF THE INVENTION

Embodiments of the invention will now be described, by way of example only, with reference to the accompanying drawings.

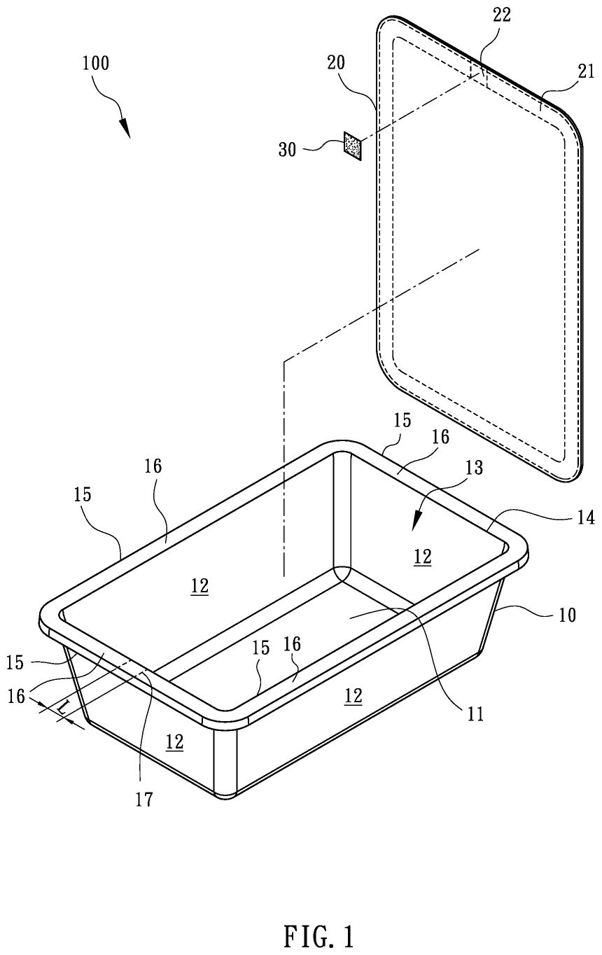

Referring to FIGS. 1 to 5, a food container (hereinafter called container) 100 in accordance with a first preferred embodiment of the invention is shown. The container 100 is adapted to contain liquid food, solid food, and/or frozen food all can be heated by microwave. The container 100 comprises a case 10, a closure device 20, and a non-sticky after heated lacquer layer 30 as discussed in detail below.

In an embodiment, the case 10 includes a base 11, four sides 12, a space 13 defined by the base 11 and the sides 12 for containing food, an opening 14 defined by tops of the sides 12, a peripheral flange 15 on tops of the sides 12, a heat joining area 16 on the peripheral flange 15 to be joined the closure device 20, and a first less adhesive area 17 formed on the heat joining area 16 and having a length ranged from 6 mm to 15 mm. But the length of the first less adhesive area 17 may be not in the range in other embodiments.

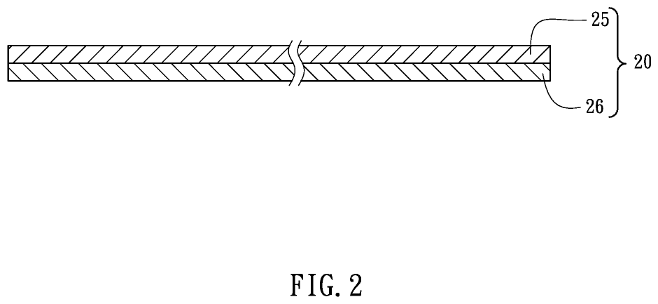

In an embodiment, the closure device 20 is configured to put on the peripheral flange 15 of the case 10 to close the opening 14 of the case 10. The closure device 20 includes a heat joining area 21 corresponding to the heat joining area 16. The heat joining area 21 is at a peripheral edge of the closure device 20 or near the peripheral edge of the closure device 20. The heat joining area 21 is indicated by dashed lines in FIG. 1. The closure device 20 further comprises a second less adhesive area 22 corresponding to the first less adhesive area 17 which is indicated by dashed lines in FIG. 1. Length of the second less adhesive area 22 is equal to length L of the first less adhesive area 17. In an embodiment, the closure device 20 is formed of a material adapted to adhere to the case 10. Basically, materials of the closure device 20 and the case 10 are different because different materials can make a release of the closure device 20 from the case 10 easier. As shown in FIG. 2, the closure device 10 includes a heat sealing layer 25 and an outer layer 26 attached to the heat sealing layer 25. The outer layer 26 serves as an enhanced layer and/or for printing purposes. The outer layer 26 may be a multi-layer structure such as a two-layer or three-layer structure.

In an embodiment, the non-sticky after heated lacquer layer 30 is provided between the peripheral flange 15 of the case 10 and the closure device 20. Specifically, the non-sticky after heated lacquer layer 30 is located between the first less adhesive area 17 and the second less adhesive area 22. The heat sealing layer 25 contacts with and is air-tightly secured to the peripheral flange 15 by heating. The outer layer 26 is reserved for printing and does not contact with the peripheral flange 15.

In an embodiment, the non-sticky after heated lacquer layer 30 is formed of hot lacquer type heat sealant having a serial number AD-1790-15 produced by TOYO-MORTON, LTD. In another embodiment, the non-sticky after heated lacquer layer 30 is liquid EVA (ethylene vinyl acetate) resin for coating. The non-sticky after heated lacquer layer 30 is formed on the second less adhesive area 22 by printing. The non-sticky after heated lacquer layer 30 is very thin and has a thickness ranged from 0.35 mm to 0.65 mm, preferably ranged from 0.45 mm to 0.55 mm, and a length equal to that of the second less adhesive area 22. After adhering the non-sticky after heated lacquer layer 30 to both the case 10 and the closure device 20, the heat sealing position is less adhesive so that after opening the heat sealing position, the heat sealing position will not close again. Materials of the food container 100 of the invention are tabulated in Table 1 below.

TABLE 1

| | closure device | | non-sticky after heated |
|---|---|---|---|
| case | Outer layer | heat sealing layer | lacquer layer |
| PP | PET | LLDPE | EVA resin |
| PE | PET | CPP | EVA resin |

In an embodiment, materials of the case 10 are mainly PP (Polypropylene) and a small amount of PE (Polyethylene) or other materials ranged from 7% to 8%. Further, it is possible of adding PP or other materials ranged from 7% to 8% to PE. Furthermore, material of the heat sealing layer 25 is LLDPE (linear low-density polyethylene) and material of the outer layer 26 is PET (polyethylene terephthalate) if material of the case 10 is PP. Alternatively, material of the heat sealing layer 25 is CPP (case polypropylene) and material of the outer layer 26 is PET if material of the case 10 is PE. PET may increase structural strength of the closure device 20 and make printing easy.

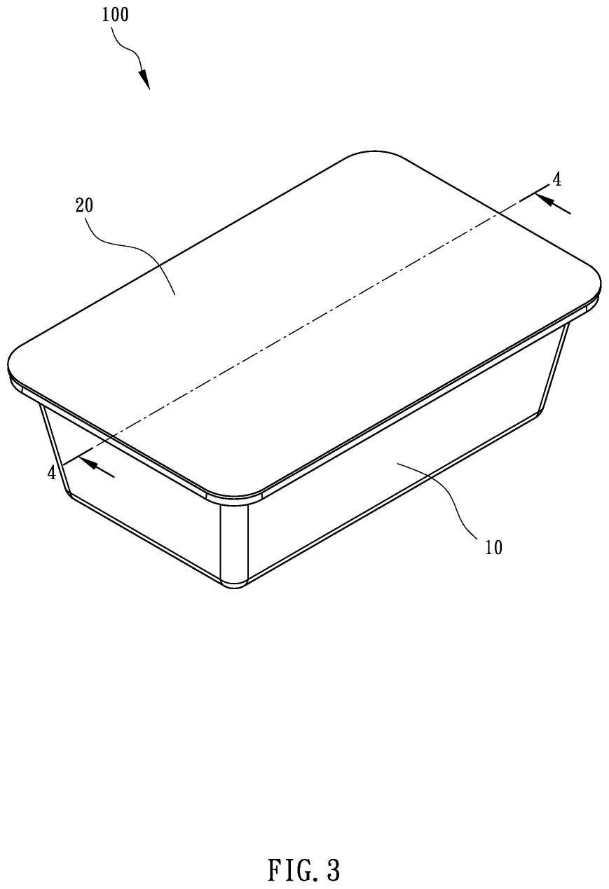

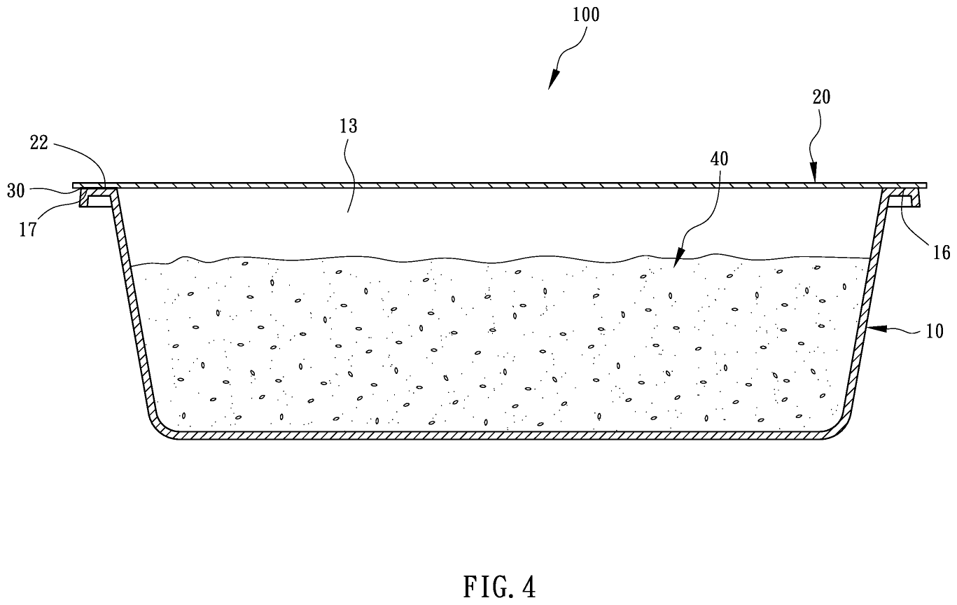

Referring to FIGS. 3 and 4, the container 100 has been sealed by a conventional heat sealing machine such as ultrasonic heat sealing machine. A detailed description thereof is omitted herein for the sake of brevity. In FIG. 4, food 40 is contained in the space 13.

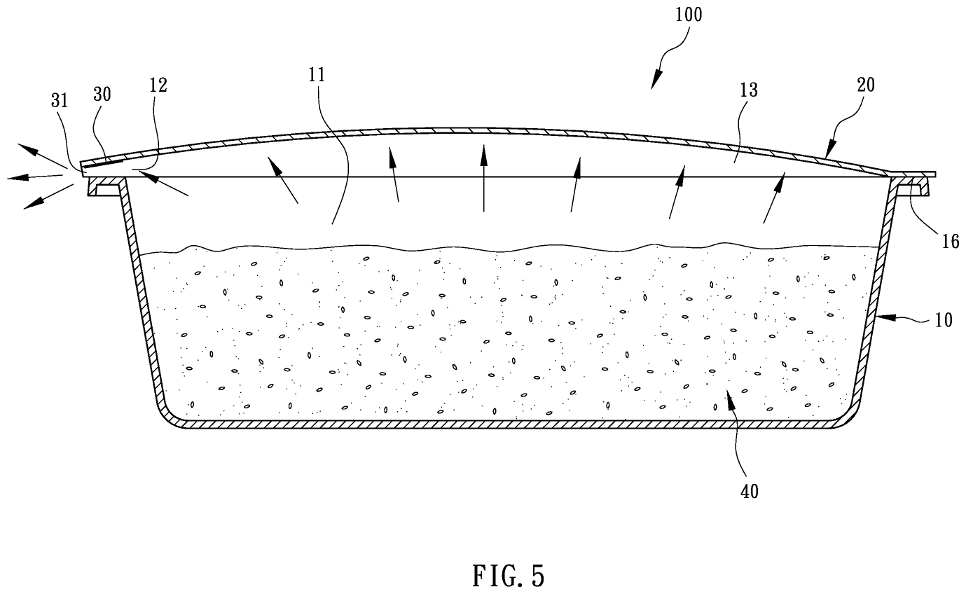

Referring to FIG. 5 in conjunction with FIGS. 3 and 4, it shows the container 100 has been heated by microwave. As shown, water in the food 40 has evaporated to form steam (indicated by arrows) and pressure in the space 13 is increased greatly due to heat. The non-sticky after heated lacquer layer 30 is softened by the heat to become non-sticky. The non-sticky after heated lacquer layer 30 does not adhere to the first less adhesive area 17 or the second less adhesive area 22. Thus, an exit 31 is formed between the first less adhesive area 17 and the second less adhesive area 22. Therefore, pressure in the space 13 may release out of the exit 31. After a plurality of experiments, it is found that all steam can quickly leave the space 13 without obstructions.

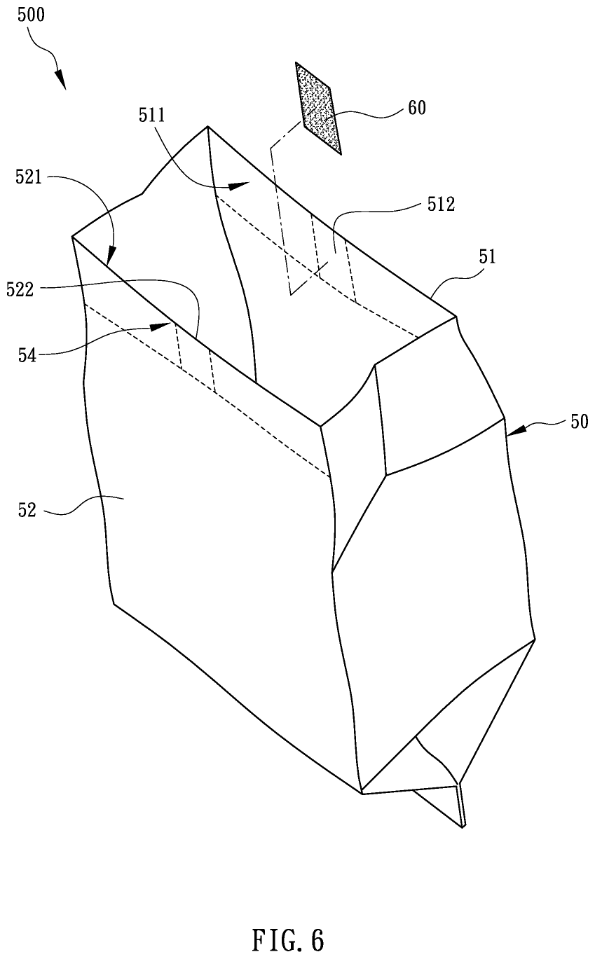

Referring to FIGS. 6 to 11, a food container (hereinafter called container) 500 in accordance with a second preferred embodiment of the invention is shown. The container 500 is adapted to contain liquid food, solid food, and/or frozen food all can be heated by microwave. The container 500 comprises a bag 50 and a non-sticky after heated lacquer layer 60 as discussed in detail below.

In an embodiment, the bag 50 includes an upper shell 51, a lower shell 52 having two sides and a first end formed with the upper shell 61, a space 53 defined by the upper shell 51 and the lower shell 52 for containing food, an opening 54 at second ends of both the upper shell 51 and the lower shell 52, an upper heat joining area 511 on the upper shell 51 facing the opening 54, an upper less adhesive area 512 formed on an intermediate portion of the upper heat joining area 511, a lower heat joining area 521 on the lower shell 52 facing the upper heat joining area 511, and a lower less adhesive area 522 formed on an intermediate portion of the lower heat joining area 521 and aligned with the upper less adhesive area 512. Each of the upper less adhesive area 512 and the lower less adhesive area 522 has a length ranged from 6 mm to 15 mm indicated by dashed lines. It is also noted that locations of both the upper less adhesive area 512 and the lower less adhesive area 522 are indicated by dashed lines and this means that the upper less adhesive area 512 may be located at other place of the upper heat joining area 511 and/or the lower less adhesive area 522 may be located at other place of the lower heat joining area 521.

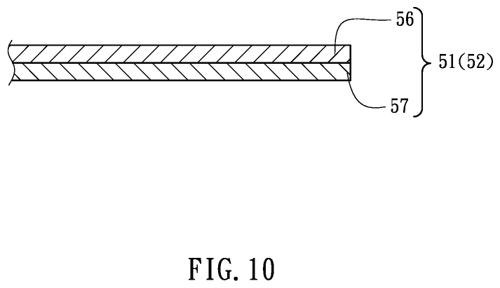

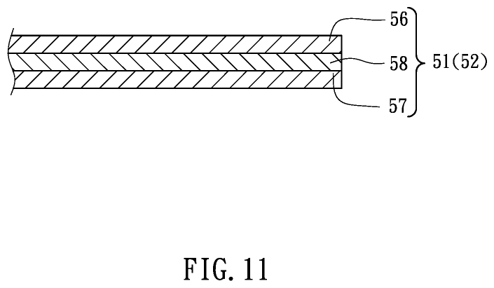

In an embodiment, both the upper shell 51 and the lower shell 52 are formed of a heat melting material. Preferably, both the upper shell 51 and the lower shell 52 are formed of the same heat melting material. The bag 50 is sufficiently strong to contain food 40. Each of the upper shell 51 and the lower shell 52 includes a heat sealing layer 56 and an outer layer 57 attached to the heat sealing layer 56 (see FIG. 10). Alternatively, each of the upper shell 51 and the lower shell 52 includes a heat sealing layer 56, an outer layer 57, and an intermediate layer 58 attached to both the heat sealing layer 56 and the outer layer 57 (see FIG. 11). In another embodiment, the upper shell 51 and the lower shell 52 are formed integrally to form the bag 50. In yet another embodiment, the upper shell 51 and the lower shell 52 are formed separately prior to joining to form the bag 50.

In an embodiment, the non-sticky after heated lacquer layer 60 is provided between the upper shell 51 and the lower shell 52. Specifically, the non-sticky after heated lacquer layer 60 is located between the upper less adhesive area 512 and the lower less adhesive area 522. The non-sticky after heated lacquer layer 60 is formed of hot lacquer type heat sealant having a serial number AD-1790-15 produced by TOYO-MORTON, LTD. In another embodiment, material of the non-sticky after heated lacquer layer 60 is EVA resin for coating. The non-sticky after heated lacquer layer 60 is formed on the upper less adhesive area 512 or the lower less adhesive area 522 by printing. The non-sticky after heated lacquer layer 60 is very thin and has a thickness ranged from 0.35 mm to 0.65 mm, preferably ranged from 0.45 mm to 0.55 mm, and a length equal to that of the upper less adhesive area 512 or the lower less adhesive area 522. After adhering the non-sticky after heated lacquer layer 60 to both the upper less adhesive area 512 and the lower less adhesive area 522, the heat sealing position is less adhesive so that after opening the heat sealing position, the heat sealing position will not close again. Materials of the food container 500 of the invention are tabulated in Table 2 below.

TABLE 2

| | Upper shell/lower shell | | | |
|---|---|---|---|---|
| | | Inter- | heat | non-sticky |
| Serial | Outer | mediate | sealing | after heated |
| number | layer | layer | layer | lacquer layer |
| 1 | nylon | — | LLDPE | EVA resin |
| 2 | nylon | — | CPP | EVA resin |
| 3 | PET | — | LLDPE | EVA resin |
| 4 | PET | — | CPP | EVA resin |
| 5 | PET | nylon | LLDPE | EVA resin |
| 6 | PET | nylon | CPP | EVA resin |
| 7 | OPP | — | CPP | EVA resin |

In Table 2, in an embodiment, serial numbers 1 to 6 show material of the heat sealing layer 56 is either LLDPE or CPP, and material of the outer layer 57 is nylon or PET. Further, serial numbers 5 and 6 show material of the intermediate layer 58 between the heat sealing layer 56 and the outer layer 57 is nylon. In Table 2, in an embodiment, serial number 7 shows material of the heat sealing layer 56 is CPP, and material of the outer layer 57 is OPP (oriented polypropylene). Materials nylon, PET and OPP not only increase the structural strength of both the upper shell 51 and the lower shell 52 but also make printing easy.

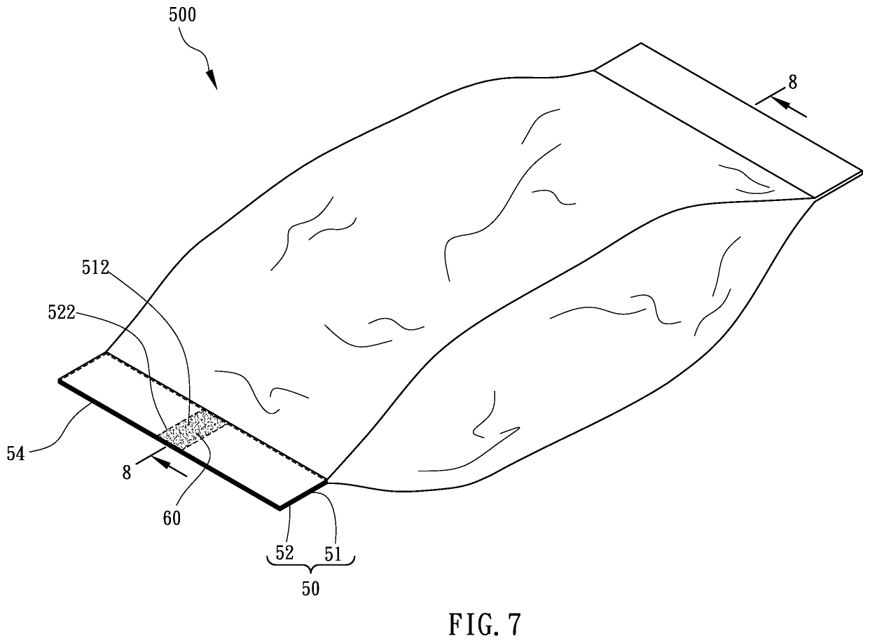

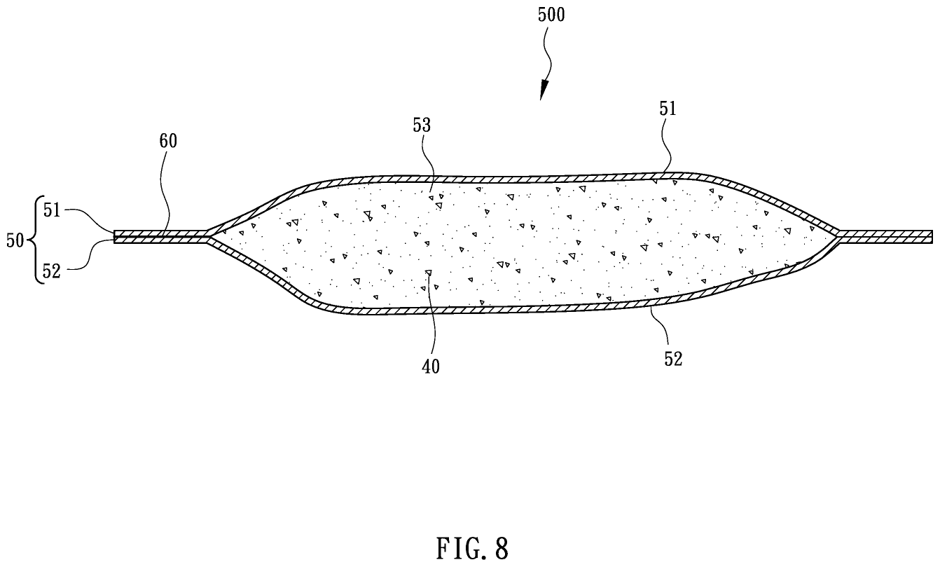

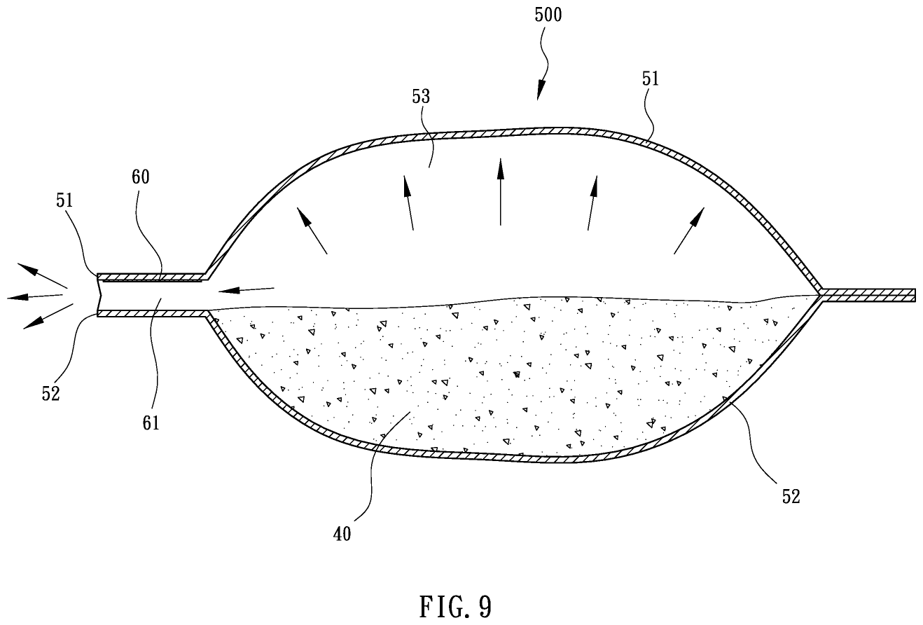

Referring to FIGS. 8 and 9 in conjunction with FIGS. 6 and 7, the container 500 has been sealed by a conventional heat sealing machine such as ultrasonic heat sealing machine. A detailed description thereof is omitted herein for the sake of brevity. In FIG. 8, food 40 is contained in the space 53. Further, in FIG. 9, it shows the container 500 has been heated by microwave. As shown, water in the food 40 has evaporated to form steam (indicated by arrows) and pressure in the space 53 is increased greatly due to heat. The non-sticky after heated lacquer layer 60 is softened by the heat to become non-sticky. The non-sticky after heated lacquer layer 60 does not adhere to the lower less adhesive area 522 of the lower heat joining area 521 or the upper less adhesive area 512 of the upper heat joining area 511. Thus, an exit 61 is formed between the lower less adhesive area 522 and the upper less adhesive area 512. Therefore, pressure in the space 53 may release out of the exit 61. After a plurality of experiments, it is found that all steam can quickly leave the space 53 without obstructions.

While the invention has been described in terms of preferred embodiments, those skilled in the art will recognize that the invention can be practiced with modifications within the spirit and scope of the appended claims.

What is claimed is:

1. A food container, comprising:
a case including an inside space for containing food, an opening for the space to be communicated with an outside environment, a peripheral flange formed on tops of the case, a first heat joining area formed on the peripheral flange, and a first less adhesive area formed on a predetermined position of the first heat joining area;
a closure device including an outer layer, a heat sealing layer attached to the outer layer and configured to attach to the peripheral flange, a second heat joining area formed on a peripheral edge of the closure device and corresponding to the first heat joining area, and a second less adhesive area formed on a predetermined position of the second heat joining area and corresponding to the first less adhesive area; and
a non-sticky after heated lacquer layer, between the peripheral flange of the case and the closure device, disposed at both the first less adhesive area and the second less adhesive area;
wherein the case is formed of a first material and the closure device is formed of a second material configured to join the first material by heating so that after joining the closure device and the case by heating, the first heat joining area and the second heat joining area are secured together, the first less adhesive area and the second less adhesive area are secured together, water in the food evaporates to form steam, pressure of the space is increased, the non-sticky after heated lacquer layer is softened by the heat to become non-sticky, the non-sticky after heated lacquer layer does not adhere to the second less adhesive area or the first less adhesive area to form an exit between the first less adhesive area and the second less adhesive area, the pressure in the space is released through the exit, and the steam in the space leaves the space through the exit.

2. The food container as claimed in claim 1, wherein a material of the case is PP or contains PP, a material of the heat sealing layer of the closure device is LLDPE, a material of the outer layer is PET, and the non-sticky after heated lacquer layer is formed of hot lacquer type heat sealant having a serial number AD-1790-15 produced by TOYO-MORTON, LTD.

3. The food container as claimed in claim 1, wherein a material of the case is PE or contains PE, a material of the heat sealing layer of the closure device is CPP, a material of the outer layer is PET, and the non-sticky after heated lacquer layer is formed of hot lacquer type heat sealant having a serial number AD-1790-15 produced by TOYO-MORTON, LTD.

4. The food container as claimed in claim 1, wherein the non-sticky after heated lacquer layer has a length ranged from 6 mm to 15 mm, and a thickness ranged from 0.35 mm to 0.65 mm.

5. The food container as claimed in claim 1, wherein a material of the non-sticky after heated lacquer layer is EVA resin for coating.

6. A food container, comprising:
a bag including an upper shell, a lower shell having two sides and a first end formed with the upper shell, a space defined by the upper and lower shells for containing food, an opening at second ends of the upper and lower shells, an upper heat joining area on the upper shell facing the opening, an upper less adhesive area formed on a predetermined position of the upper heat joining area, a lower heat joining area formed on the lower shell facing the upper heat joining area, and a lower less adhesive area formed on a predetermined position of the lower heat joining area and aligned with the upper less adhesive area; and
a non-sticky after heated lacquer layer, between the upper shell and the lower shell, disposed at both the upper less adhesive area and the lower less adhesive area;
wherein after sealing the opening of the bag by heating, the upper and lower heat joining areas are secured together, the upper and lower less adhesive areas are secured together by the non-sticky after heated lacquer layer, water in the food evaporates to form steam, pressure of the space is increased, the non-sticky after heated lacquer layer is softened by the heat to become non-sticky, the non-sticky after heated lacquer layer does not adhere to the lower less adhesive area or the upper less adhesive area to form an exit between the upper less adhesive area and the lower less adhesive area, the pressure in the space is released through the exit, and the steam in the space leaves the space through the exit.

7. The food container as claimed in claim 6, wherein a material of the heat sealing layer of each of the upper shell and the lower shell is LLDPE or CPP, a material of the outer layer is PET, and the non-sticky after heated lacquer layer is formed of hot lacquer type heat sealant having a serial number AD-1790-15 produced by TOYO-MORTON, LTD.

8. The food container as claimed in claim 7, wherein a material of the intermediate layer between the heat sealing layer and the outer layer is nylon.

9. The food container as claimed in claim 6, wherein a material of the heat sealing layer of each of the upper shell and the lower shell is CPP, a material of the outer layer is OPP, and the non-sticky after heated lacquer layer is formed of hot lacquer type heat sealant having a serial number AD-1790-15 produced by TOYO-MORTON, LTD.

10. The food container as claimed in claim 6, wherein a material of the non-sticky after heated lacquer layer is EVA resin for coating.

11. The food container as claimed in claim 6, wherein the non-sticky after heated lacquer layer has a length ranged from 6 mm to 15 mm, and a thickness ranged from 0.35 mm to 0.65 mm.

12. A closure device configured to seal a food container, comprising a heat sealing layer, an outer layer, a heat joining area formed on the closure device, a less adhesive area formed on a predetermined position of the heat joining area, and a non-sticky after heated lacquer layer formed on the less adhesive area.

13. The closure device as claimed in claim 12, wherein a material of the heat sealing layer is LLDPE or CPP, a material of the outer layer is nylon or PET, and the non-sticky after heated lacquer layer is formed of hot lacquer type heat sealant having a serial number AD-1790-15 produced by TOYO-MORTON, LTD.

14. The closure device as claimed in claim 13, wherein a material of the intermediate layer between the heat sealing layer and the outer layer is nylon.

15. The closure device as claimed in claim 12, wherein a material of the heat sealing layer is CPP, a material of the outer layer is OPP, and the non-sticky after heated lacquer layer is formed of hot lacquer type heat sealant having a serial number AD-1790-15 produced by TOYO-MORTON, LTD.

16. The closure device as claimed in claim 12, wherein a material of the non-sticky after heated lacquer layer is EVA resin for coating.
